(19) United States
(12) Patent Application Publication
(10) Pub. No.: US 2016/0362152 A1
(43) Pub. Date: Dec. 15, 2016

(54) Modular and Multi-purpose traler of the grain cart type

(71) Applicant: Carina Edit Balonchard, Kennesaw, GA (US)

(72) Inventor: Carina Edit Balonchard, Kennesaw, GA (US)

(21) Appl. No.: 14/738,840

(22) Filed: Jun. 13, 2015

(51) Int. Cl. B62D 63/06; B60P 1/40

(52) U.S. Cl. CPC B62D 63/061; B60P 1/40

(57) ABSTRACT

This invention is an agricultural trailer which has the specific characteristics of being modular and multi-purpose. The modularity is achieved via the use of hopper modules—or modules of another type—which are designed to be easily mounted and dismounted, and that are affixed on a common platform. The platform itself is also modular, allowing for the mounting and dismounting of even more modules than the basic platform can accommodate. This modularity allows to increase or to decrease the trailer's carrying capacity in accordance with the user needs and it enables to use the trailer for different agricultural purposes.

The multi-purpose nature of the trailer is achieved via the use of modules with differing functionalities.

### BACKGROUND OF THE INVENTION

### Current State of Technology and Problems Solved by the Invention

Today, most agricultural trailers of the ‘grain cart’ type share the same characteristics, most of which date back to the original U.S. Pat. No. 2,438,301 (issued on 23 Mar. 1948).

Consequent improvements have been made to the original model. Most of these patents relate to the grain discharge via an auger of the ‘endless’ type (examples: U.S. Pat. No. 2,743,571, issued 1 May 1956; U.S. Pat. No. 3,575,306, issued on 20 Apr. 1971, U.S. Pat. No. 4,095,705, issued on 20 Jun. 1978; U.S. Pat. No. 4,846,621, issued 11 Jul. 1989; U.S. Pat. No. 4,923,358, issued 8 May 1990; U.S. Pat. No. 5,100,281, issued on 31 Mar. 1992; U.S. Pat. No. 5,108,249, issued 28 Apr. 1992; U.S. Pat. No. 5,516,253, issued 14 May 1996; U.S. Pat. No. 6,113,339, issued on 5 Sep. 2000; U.S. Pat. No. 6,119,847, issued on 19 Sep. 2000).

Other patents relate to the horizontal conveying of the bulk inside the cart's hopper, either via a screw conveyor (example: U.S. Pat. No. 5,733,094, issued on 31 Mar. 1998) or via a transport belt, allowing the use of this type of cart for fertilizer spreading (example: U.S. Pat. No. 3,220,740, issued on 30 Nov. 1965). Later patents have allowed this type of cart to be additionally used as a seed tender (example: U.S. Pat. No. 6,893,202, issued on 17 May 2005).

Looking at the evolution of patents, one can see that there is a move towards multi-purpose use of the grain carts (similar types of carts can now be used for grain transport from the combine to the loading truck and for seed transport to the seed drill, for instance).

However, the current technology has its limitations.

First of all, because of the fixed size of the bins which are fitted on the grain carts. Traditionally, the work of receiving grain from a combine and transporting it to the grain lorry requires bin capacities starting at 6,000 litres. Many manufacturers produce carts with capacities over 20,000 litres. However, even the biggest of the direct seeding seed drills, with a labour width of 14 meters, only have seed reservoirs of 5,000 litres. The result is that the common grain carts are too big for being used as a seed tender for most of the seed drills. More importantly, the smaller the agricultural enterprise, the bigger the mismatch is between the required size of grain cart and the required size of the seed tender.

Secondly, although there has been some technology that allows the use of the same machine for multiple purposes, the current state of technology only allows the use of the same machine for 2 different activities. For example, U.S. Pat. No. 6,893,202 (issued on 17 May 2005) allows to use the grain cart as a seed tender, through the addition of a chute that allows to dump the seeds onto the seed drill conveyor's intake hopper. U.S. Pat. No. 3,561,681 (issued on 9 Feb. 1971) provides for the dual use of the grain cart as a fertilizer spreader, through the presence of an unloading auger, a horizontal transport belt and spreading apparatus at the back. The limitations of these technologies however, is that they do not allow for additional uses other than the 2 provided, and that all of the present equipment is fixed, without possibility to be easily removed, replaced or refitted when the need requires so.

Our invention eliminates these two limitations of the current state of technology. We have invented a trailer that consists of a basic chassis, onto which one or more hopper bin modules or other types of modules can be fitted. The addition of each module increases (and the removal of each module decreases) the storage or functional capacity of the trailer in function of the user requirements, and these modules can also change the trailer's functionality (for example: a closed bin module allows for using the trailer as a classic grain cart; the use of a fertilizer spreading module will allow to use the trailer as a fertilizer spreader, for instance). Additionally, the basic chassis can be expanded with additional chassis modules so as to incrementally increase the size of the trailer's chassis and—consequently—its carrying capacity, allowing for the fitting of additional hopper modules.

The chassis modules are designed to easily fit into each other with a sliding movement, and are securely fastened with the technology described below. The modules that are placed onto the chassis are designed to be easily mounted onto any possible chassis configuration and connected to each other, via the standardization and the fixation methods described below.

The multi-functionality of the trailer is further achieved through the invention of a modular transportation belt: while extensions are added to the basic chassis, the horizontal transportation belt that is inside the basic chassis connects with a belt extension inside the chassis extension.

### BRIEF SUMMARY OF THE INVENTION

This invention is an agricultural trailer which has the specific characteristics of being modular and multi-purpose. The modularity is achieved via the use of hopper modules—or modules of another type—which are designed to be easily mounted and dismounted, and that are affixed on a common platform. The platform itself is also modular, allowing for the mounting and dismounting of even more modules than the basic platform can accommodate. This modularity allows to increase or to decrease the trailer's carrying capacity in accordance with the user needs and it enables to use the trailer for different agricultural purposes.

The multi-purpose nature of the trailer is achieved via the use of modules with differing functionalities.

### BRIEF DESCRIPTION OF THE SEVERAL VIEWS OF THE DRAWING

FIG. 1 shows a standard configuration of the invention in its whole, consisting of the basic chassis, three hopper bin modules and a standard unloading auger.

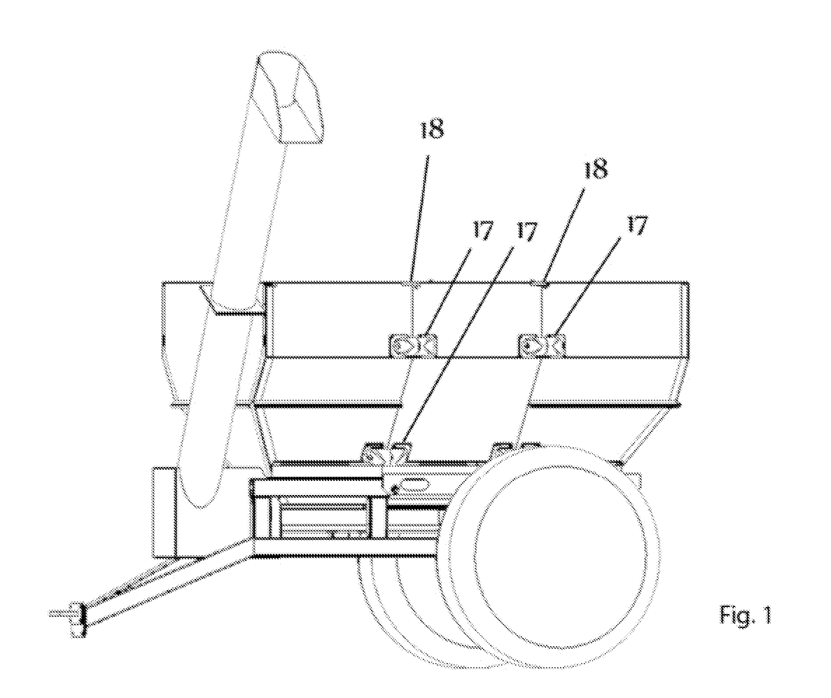

FIG. 2 shows front and back hopper bin modules.

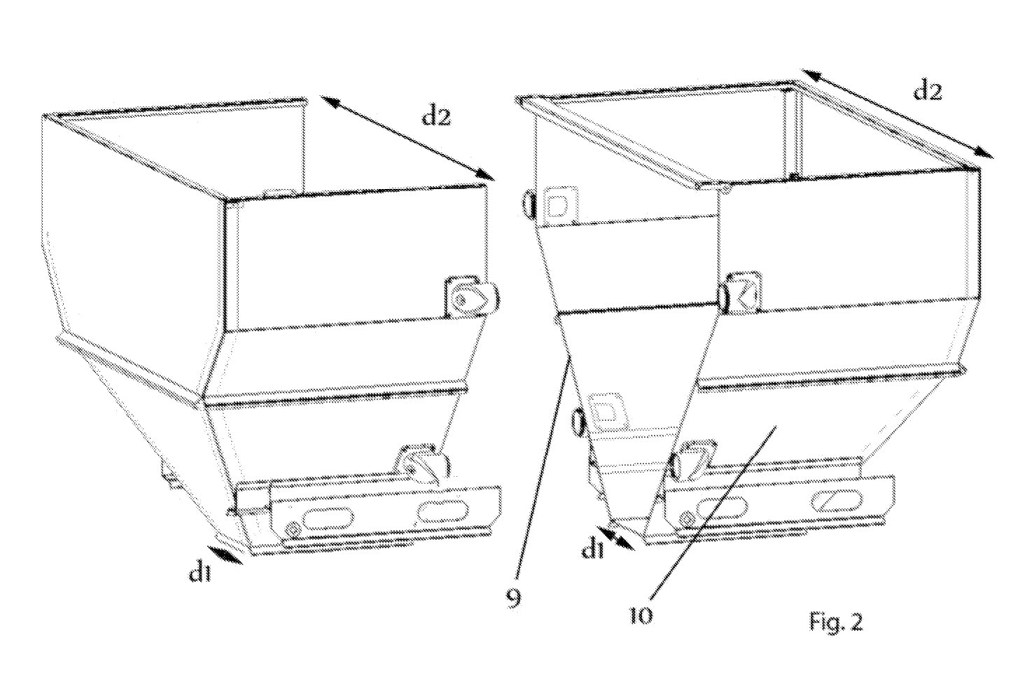

FIG. 3 shows the method for affixing and fastening the aforementioned front and back hopper bin modules onto the basic chassis or on the chassis extension.

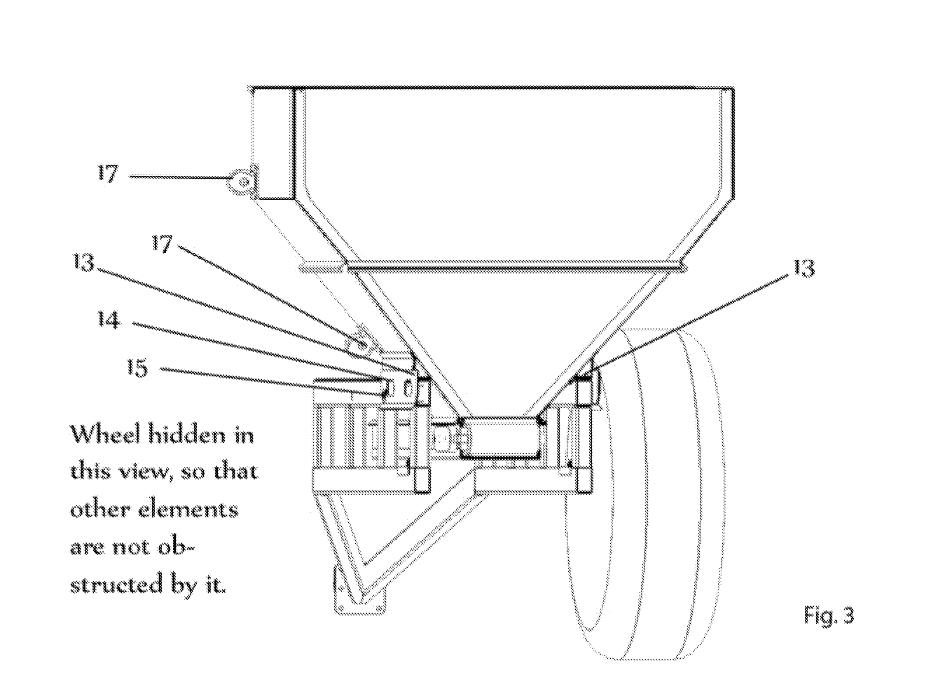

FIG. 4 shows the middle hopper bin module that can be affixed, alone or together with other similar modules, to the basic chassis or the chassis extension and removed from them.

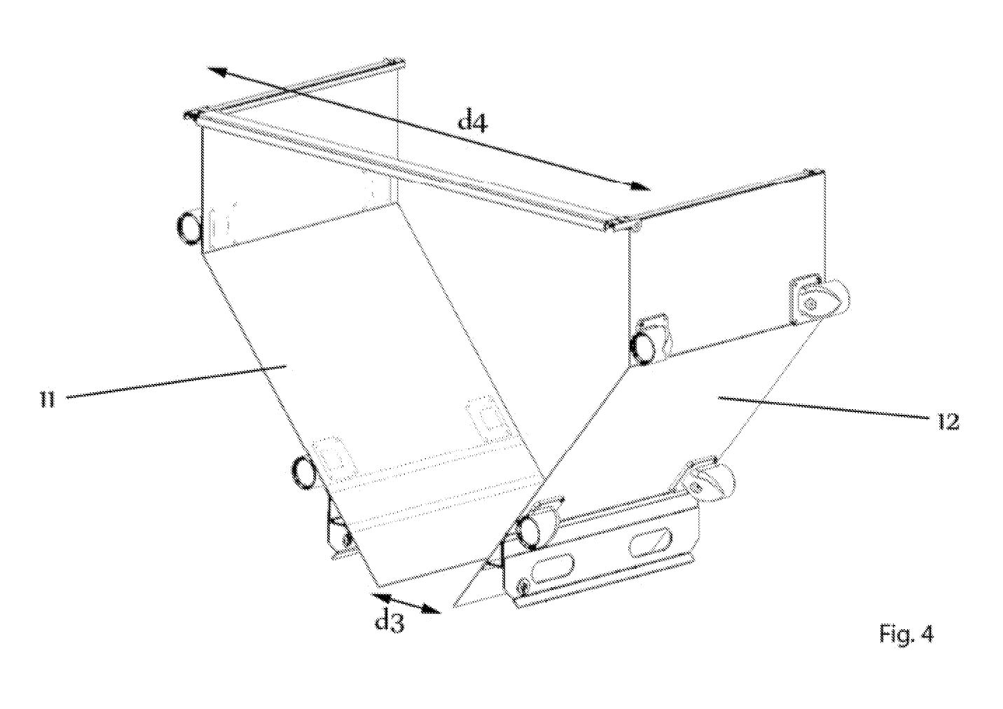

FIG. 5 shows the method of affixing and fastening of said middle module onto the basic chassis or on the chassis extension.

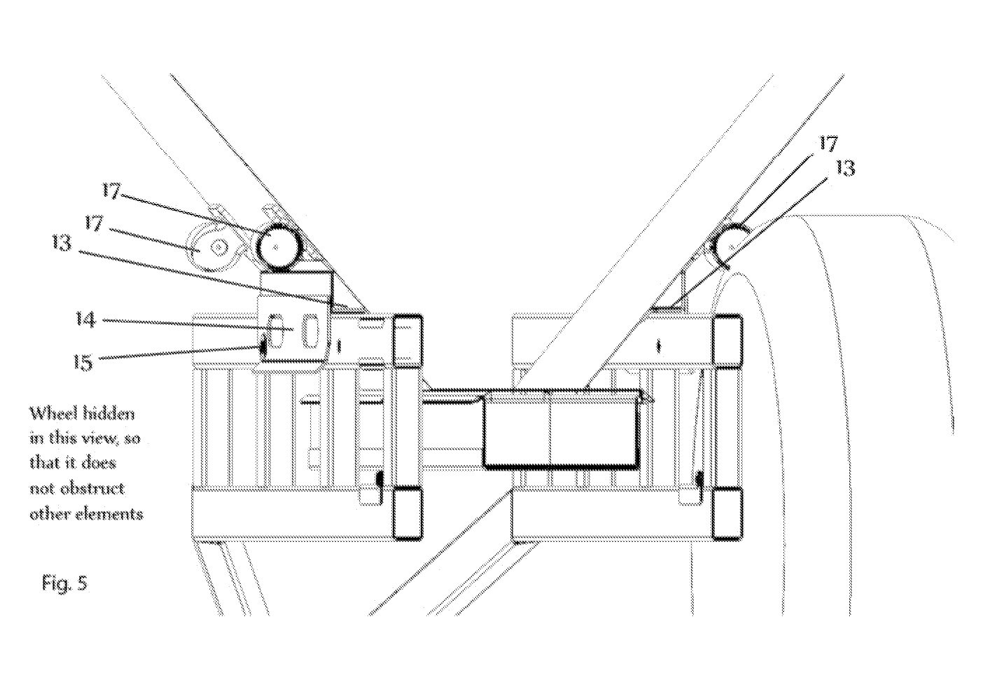

FIG. 6 shows the method of fixation for the upper part of any 2 adjacent modules

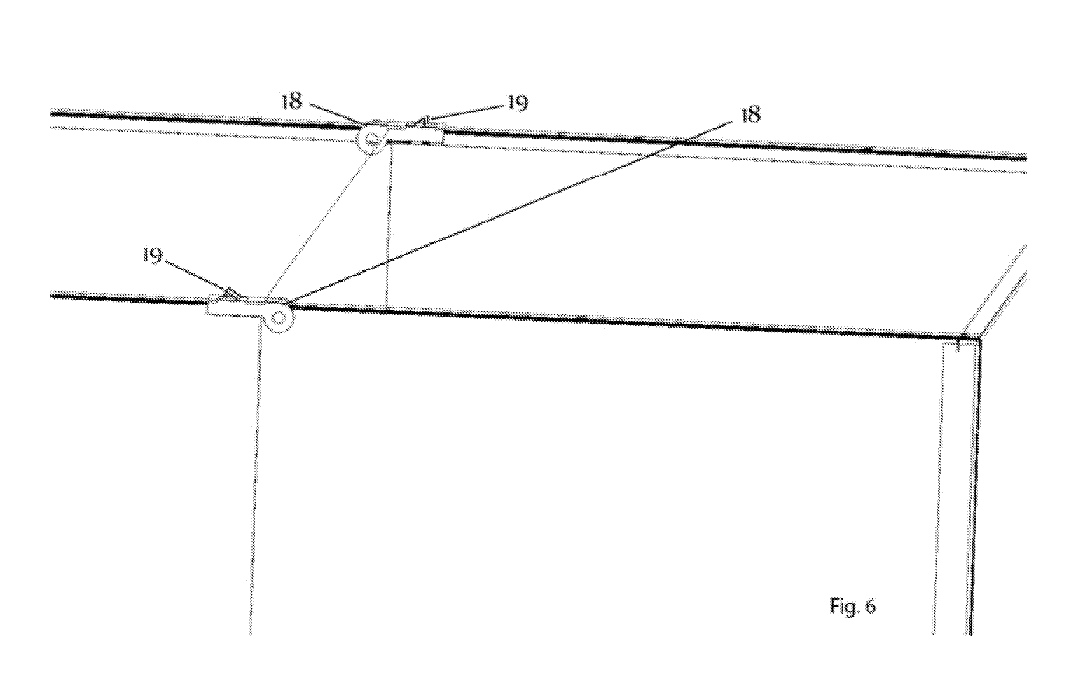

FIG. 7 shows the main chassis and the chassis extension that can be slid into the basic chassis.

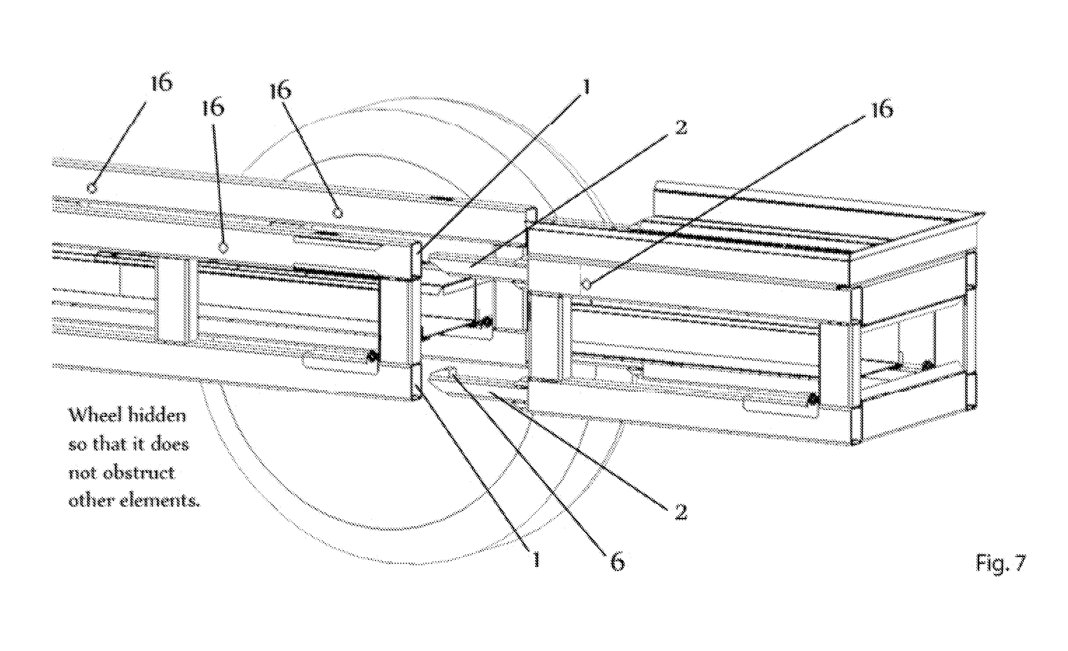

FIG. 8 shows the method of fastening such chassis extension into the basic chassis.

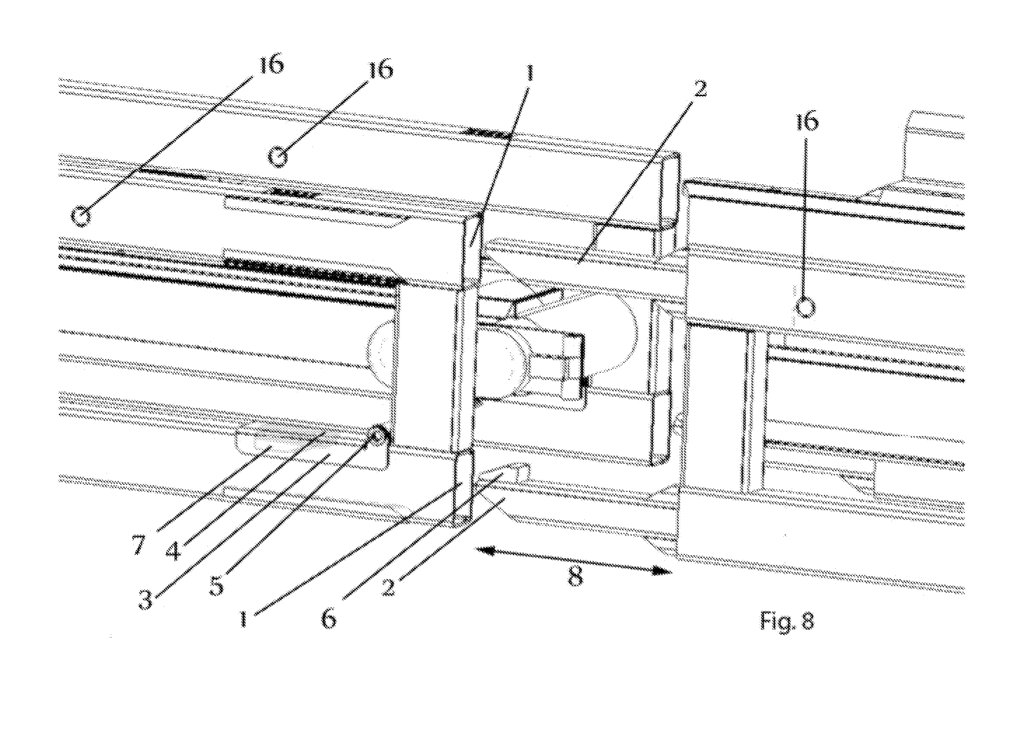

FIG. 9 shows how the transportation belt that is integrated into the basic chassis connects with the transportation belt that is integrated into the chassis extensions.

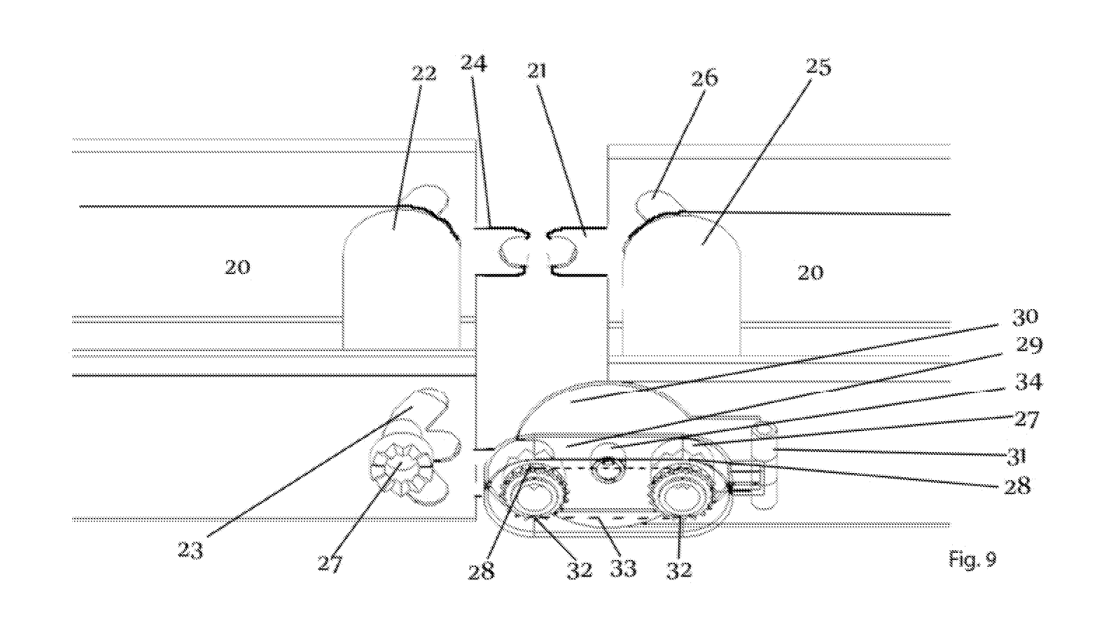

FIG. 10 shows how two transport belt sections can be rotated into different relative positions.

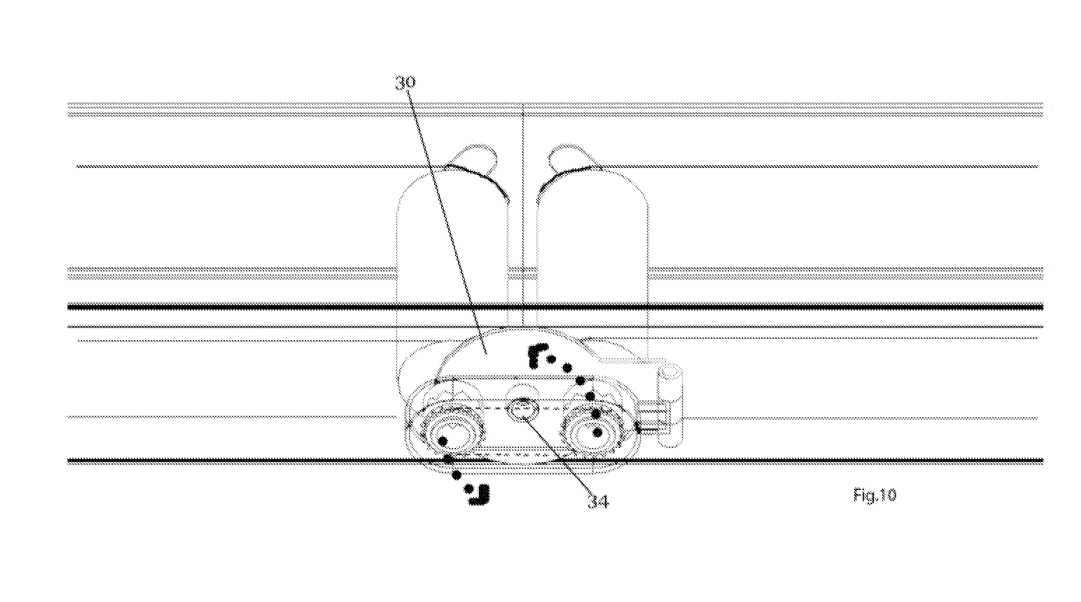

FIG. 11 shows an alternative configuration of the invention in its whole, consisting of the basic chassis, 1 extension chassis, 4 hopper bin modules and a standard unloading auger.

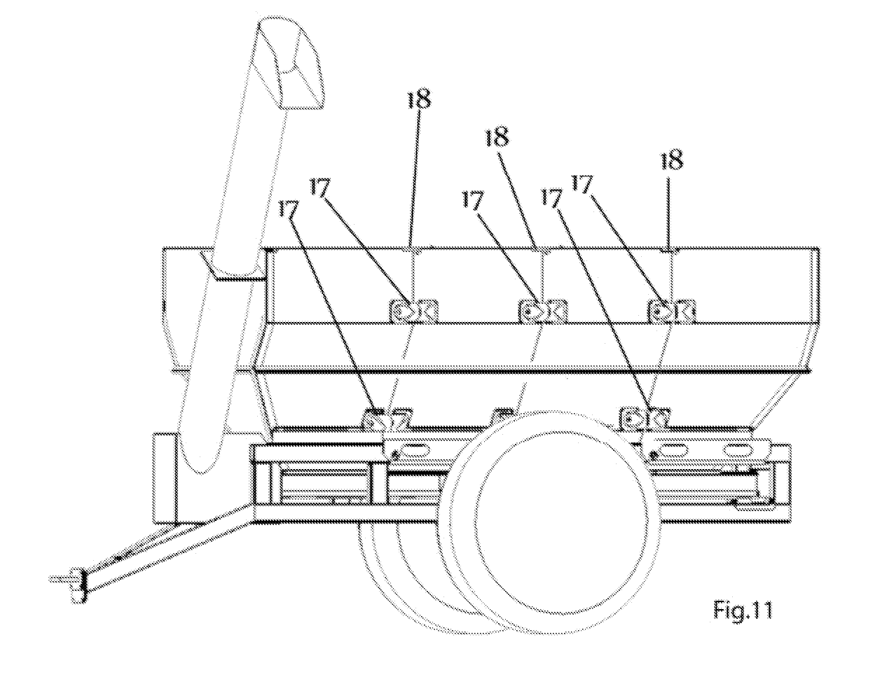

### DETAILED DESCRIPTION OF THE INVENTION

In all drawings, the same reference numbers refer to equal or corresponding elements.

In my invention, I have achieved the modularity of the trailer by creating a chassis that is equipped to receive chassis extensions at the back (as shown in drawing 9 and drawing 10), and through the design of basic and additional modules that can be fitted onto the basic chassis (as shown in drawing 2, drawing 3, drawing 4 and drawing 5), as well as onto the chassis extensions (as shown in drawing 13).

Inside the basic chassis sits a transport belt, and inside the chassis extension sits an integrated transport belt extension, which automatically connects with the transport belt integrated into the basic chassis. Both transport belt elements can be adjusted so that the transport belt can operate in two directions (transport to the front of the trailer and transport to the back of the trailer), as shown in drawing 12.

### Chassis Extensions

Each of the chassis' horizontal beams is built so that, at the back-end side, there is an opening, wider on the extremities and narrower nearer towards the center of the chassis (hereinafter referred to as “guiders”)—number 1 in drawings 9 and 10. These guiders are designed to receive similarly shaped protrusions—number 2 in drawings 9 and 10—on the chassis extension's equivalent beams.

The main chassis' beams have a mobile element at the top, near the rear end, as shown by number 3 in drawing 10. This mobile acts as a lid on an opening on top of the chassis beam (number 4 in drawing 10). It is attached to such beam with a hinge (number 5 in drawing 10). This hinge allows the element 4 to swing open and be closed. In its closed position, an extrusion on the chassis' mobile element (number 6 on drawings 9 and 10) prevents the chassis extension, which also has an extrusion at that spot (number 7 on drawing 10), to move horizontally and thus be released from the main chassis. In its open position, the extrusion is no longer blocking the chassis extension, and the back end chassis extension can be freely removed.

The vertical and angular movements of the chassis extension are blocked by the tight fit inside the main chassis of the extrusion on the chassis extension (number 8 in drawing 10 marks the part of the chassis extension that is fitted inside the main chassis' beam, well beyond the mobile element number 3.

### Basic and Additional Modules

The front and back modules (as shown in drawing 2) as well as the middle modules (as shown in drawing 5) have a typical hopper shape: the side panels (numbers 9 and 10 in drawing 2 and numbers 11 and 12 in drawing 5) slant inwards from top to bottom. The result is that the module's width at the bottom (distance d1 in drawing 2 and distance d3 in drawing 5) is significantly smaller than the module's width at the top (distance d2 in drawing 2 and distance d4 in drawing 5). The further result is that, through the effect of gravity, and through the support of the T-shaped support elements affixed onto the side panels (number 14 on drawing 3 and drawing 6), the module will automatically slide into its correct crosswise position.

The longitudinal position of the modules is assured via a hole on the support elements' side panel (number 15 on drawing 3 and drawing 6). In its correct longitudinal position, the aforementioned hole corresponds exactly with an equivalent hole in the chassis' upper beam (number 16 in drawings 9 and 10). Running a bolt through both aligned holes ensures the correct longitudinal position of the modules is assured.

Once the modules are in place via the previous methods, they are fastened via a traditional fixation method, such as bolts, or any other fixation method in the middle (number 17 in drawings 3, 4 and 13), and for additional fixation to prevent rotational movements, on top of the modules (as shown in drawing 8, where elements 18 and 19 represent a hinge with rectangular extrusion and corresponding triangular pins.

Via this method, various types of modules can be mounted onto the front of the basic configuration, each of them changing the load capacity of the trailer, its functionality, its appearance or a combination thereof. For example, drawing 13 shows a configuration consisting of a basic chassis with 1 chassis extension, a front module, three middle modules and a back module.

### Modular Transport Belt

Both the basic chassis and the chassis extension contain an integrated transport belt, as depicted by elements 20 in drawing 11. The transport belt transports the contents of the hopper bins forward to the unloading auger, or backwards.

Once the chassis extension is connected with the basic chassis, the protrusion indicated by number 21 in drawing 11 pushes the rearmost roller of the basic chassis transport belt (number 22) just enough forward, so that the axle of the roller can freely move upwards and downwards inside the epsilon-shaped guiders (number 23 in drawing 11). A similar protrusion on the basic chassis (number 24 in drawing 11) pushes the frontmost roller of the chassis extension (number 25) backwards, so that it too can freely move upwards and downwards in its epsilon-shaped guider.

Both rollers (numbers 22 and 25 in drawing 11) have a tooth-edged cylinder shape attached to them (numbers 27 in drawing 11) that can connect with similar tooth-edged cylinder shapes (numbers 28 in drawing 11) which are connected to a joining element (number 29). That joining element is connected to a plate (number 30) via a hinge (number 31 in drawing 11). Opening or closing the hinge will move the tooth-edged cylinder shapes away from each other or towards each other, consequently disconnecting or disconnecting the various tooth-edged cylinder shapes.

Cylinder shapes number 28 carry a gear (numbers 32) and these two gears are connected with a chain (number 33). This chain transfers the movement from the main chassis' transport belt to the extension's transport belt. As a result of this, only 1 motor is required to provide forward or backward movement to all of the segments of the transport belt.

The plate number 30 can rotate, via an axle (number 34 in drawing 12). This rotational movement pushes the rollers 22 and 25 into opposite ends of the guiders (numbers 23 and 26) of each of the transport belt segments. At the extreme positions in each of these guiders, the rollers 22 and 25 will be positioned above each other in a way that will place the end of the first transport belt section above the beginning of the second transport belt section, or inversely, below the beginning of the second transport belt section. These two positions allow for the transport belt to function in either forward or backward direction, dropping its load through gravity from 1 belt segment onto the other.

Having described and specified the nature and reach of the invention and how to put it into practice, I claim:

1. A multipurpose and modular trailer of the ‘grain cart’ type, consisting of: (1) a basic configuration; and (2) additional modules and extensions that can be affixed to, and removed from, the basic configuration; the combination of which two elements allows to change the trailer's capacity or its functionality.

2. The trailer of claim 1, where the chassis is equipped with openings at fixed distances one from the other, enabling the affixing of standardized elements (such as, but not limited to, hopper bin modules) with such standardized elements capable of being removed and refitted repeatedly and as such allowing for the trailer to be used for different purposes, or having different capacities, in function of the type and amount of standardized elements that are fixed upon it.

3. The trailer of claim 1, where the chassis of an agricultural trailer is equipped to receive extensions, in the form of a smaller sized chassis-element that can be connected to it, with such extensions capable of being removed and refitted repeatedly and as such making the total chassis larger or smaller.

4. The chassis of claim 3, where each of the chassis' horizontal beams is built so that, at the back-end side, there is an opening, wider on the extremities and narrower nearer towards the center of the chassis and where chassis extensions have similarly shaped protrusions—narrower on the extremities and wider nearer towards the center—on the equivalent beams, so that the chassis extensions can be connected to the basic chassis, so as to combine into a longer chassis;

5. A modular transport belt consisting of one or more separate transport belts that can be joined, whereby the last roller of the first of 2 belts being joined, and the first roller of the second belt are connected in a non-permanent manner to an element that turns around an axle, whereby (1) with the rotational movement around that axle, the aforementioned rollers move upwards or downwards and change their relative upwards or downwards position, thus enabling the load of the transport belt to fall through the force of gravity from one to the other belt, and (2) such element connecting the aforementioned rollers contains a chain or any other similar part that allows for the movement of the first belt to be passed onwards to the second belt.
